(19) United States
(12) Patent Application Publication
(10) Pub. No.: US 2025/0369560 A1
(43) Pub. Date: Dec. 4, 2025

(54) APPARATUS FACILITATING HANGING AND STORING OF AN OBJECT

(71) Applicant: Kelcey Michael Anthony, Ellensburg, WA (US)

(72) Inventor: Kelcey Michael Anthony, Ellensburg, WA (US)

(21) Appl. No.: 19/223,859

(22) Filed: May 30, 2025

Related U.S. Application Data
(60) Provisional application No. 63/653,613, filed on May 30, 2024.

(51) Int. Cl. F16M 13/02; A45F 3/00; A45F 3/04

(52) U.S. Cl. CPC F16M 13/02; A45F 3/04; A45F 2003/001

(57) ABSTRACT

The present disclosure provides an apparatus facilitating hanging and storing of an object. Further, the apparatus facilitating hanging and storing of an object may include a hanging tab. Further, the apparatus facilitating hanging and storing of an object may include a rail structure which may be configured for facilitate each of a receiving and a retaining of two or more hanging tabs. Further, the rail structure may include two or more shaped through-holes. Further, the each of the two or more shaped though-holes may be configured to extend completely. Further, each of the shaped through-hole may include a rounded upper portion dimensioned to securely receive the circular button portion Further, each of the shaped through-hole may include a narrow vertically elongated slit designed to extend downwardly.

The current application claims a priority to the U.S. Provisional Patent application Ser. No. 63/653,613 filed on May 30, 2024.

### FIELD OF DISCLOSURE

The present disclosure relates to the field of miscellaneous hardware. More specifically, the present disclosure relates to apparatus facilitating hanging and storing of an object.

### BACKGROUND

Organizational systems are integral to modern living and working environments, providing efficient and secure methods for storage and display. These systems are essential in both personal and industrial settings, where the ability to store items neatly, access them quickly, and ensure their security is paramount.

An objective that is desirable in this field is to enhance the efficiency, security, and versatility of storage solutions, particularly in systems designed for modular and multi-functional use. This objective aims to address the growing demands for flexible storage setups that can adapt to diverse environments while minimizing risks of dislodgment or damage.

Currently, many storage systems face significant challenges. Traditional hanging mechanisms often fail due to issues like slippage and wear over time, leading to items falling or becoming dislodged. Additionally, some systems lack flexibility in how objects are attached, making it difficult to customize storage configurations. This rigidity can result in inefficient use of space and limited organization potential.

Storage containers may struggle with efficient organization of small items such as ties, often leading to clutter. Furthermore, traditional methods for attaching accessories or mounting devices may not provide sufficient security, causing damage or instability. Environmental factors like moisture can also degrade components over time, reducing the reliability of storage systems.

Moreover, existing solutions frequently lack essential safety mechanisms, such as weight sensors or alerts for improper attachment, which could prevent accidents and ensure secure storage. These shortcomings highlight the need for improved systems that offer enhanced security, flexibility, and durability.

Therefore, there is a clear need for innovative storage solutions that can overcome these challenges, providing more efficient, secure, and versatile methods for organizing items in various settings. Therefore, there is a need for improved apparatus facilitating hanging and storing of an object.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides an apparatus facilitating hanging and storing of an object. Further, the apparatus facilitating hanging and storing of an object may include a hanging tab. Further, the hanging tab may include a circular button portion disposed at a first longitudinal end of the hanging tab. Further, the circular button portion includes a flat top surface and a flat bottom surface. Further, the circular button portion further includes a continuous cylindrical sidewall which may be configured to connect the flat top surface to the flat bottom surface. Further, the continuous cylindrical sidewall may be further configured for circumferentially enclosing the button portion. Further, the hanging tab may include a connecting shaft portion extending from the flat bottom surface of the circular button portion. Further, the connecting shaft portion may be designed to terminate at a second longitudinal end associated with the hanging tab. Further, the second longitudinal end may be positioned opposite to the first longitudinal end. Further, the connecting shaft portion includes each of an elongated profile and a uniform cross-sectional profile in relation to a longitudinal axis associated with the connecting shaft portion. Further, the connecting shaft portion may be designed to be narrower in relation to the circular button portion enabling one or more of a flexible suspension and an insertion into a slit. Further, the hanging tab may include a terminal eyelet portion disposed at the second longitudinal end of the hanging tab. Further, the terminal eyelet portion includes a flat annular ring oriented orthogonally to the longitudinal axis associated with the connecting shaft portion. Further, the flat annular ring includes a central through-hole defining an aperture which may be configured for accommodating a flexible tie member. Further, the terminal eyelet portion may be designed for integrally forming with the connecting shaft portion. Further, the integrally forming of the terminal eyelet portion with the connecting shaft portion may be configured to enable a connection of the hanging tab to the object. Further, the apparatus facilitating hanging and storing of an object may include a rail structure which may be configured for facilitate each of a receiving and a retaining of two or more hanging tabs. Further, the rail structure may include a longitudinal bar having a front surface and a rear surface. Further, the longitudinal bar may be configured for mounting onto a vertical support. Further, the rail structure may include two or more shaped through-holes defined in the front surface of the longitudinal rail. Further, the each of the two or more shaped though-holes may be configured to extend completely from the front surface to the rear surface. Further, each of the shaped through-hole may include a rounded upper portion dimensioned to securely receive the circular button portion associated with the hanging tab. Further, each of the shaped through-hole may include a narrow vertically elongated slit designed to extend downwardly from the rounded upper portion. Further, the narrow vertically elongated slit includes a width dimensioned for matching a diameter associated with the connecting shaft portion. Further, the each of the two or more hanging tabs may be configured for vertical insertion into the rail structure. Further, the vertical insertion of each of the two or more hanging tabs may be facilitated by two or more insertion steps. Further, the two or more insertion steps includes an alignment step representing aligning of the circular button portion with the rounded upper portion of each of the two or more shaped through-holes and a sliding step representing sliding of the connecting shaft portion downward through the narrow vertically elongated slit. Further, the two or more insertion steps may be configured to facilitate a mounting of each of the two or more hanging tabs to the rail structure. Further, the two or more shaped through-holes may be arranged to be spaced in one or more of a regular interval and two or more variable intervals along the longitudinal axis associated with the rail structure.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a hanging tab 100, in accordance with some embodiments.

FIG. 2 is an illustration of a plurality of hanging tabs with varied lengths, in accordance with some embodiments.

FIG. 3 illustrates an object attached to the hanging tab using each of a flexible tie member 302 and a spherical stopper 306, in accordance with some embodiments.

FIG. 4 illustrates a front view of a rail structure 400, in accordance with some embodiments.

FIG. 5 illustrates a plurality of antlers attached and hanging from the rail structure 400, in accordance with some embodiments.

FIG. 6 illustrates a plurality of objects attached and hanging from the rail structure 400, in accordance with some embodiments.

FIG. 7 illustrates a backpack adapter plate 700, in accordance with some embodiments.

FIG. 8 illustrates a tool holding bracket 800, in accordance with some embodiments.

FIG. 9 illustrates a planar mounting plate 900, in accordance with some embodiments.

FIG. 10 illustrates a modular sliding track, in accordance with some embodiments.

FIG. 11A illustrates a mounting accessory, in accordance with some embodiments.

FIG. 11B illustrates a mounting accessory, in accordance with some embodiments.

FIG. 11C illustrates a mounting accessory, in accordance with some embodiments.

FIG. 11D illustrates a mounting accessory, in accordance with some embodiments.

FIG. 11E illustrates a mounting accessory, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview:

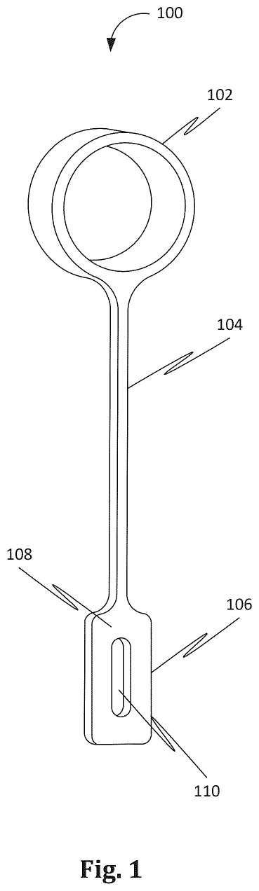

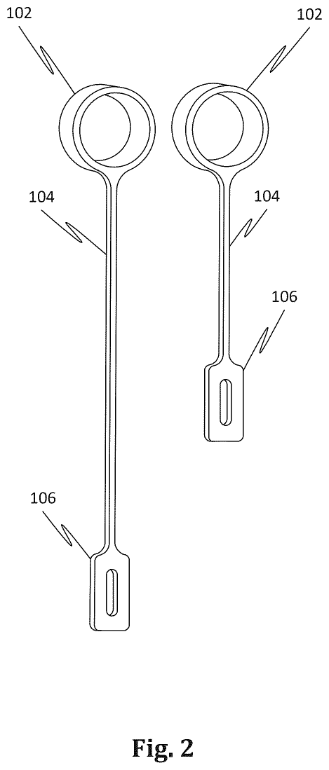

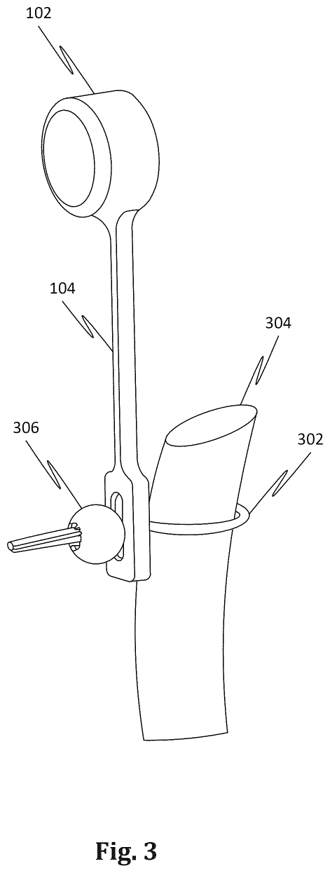

The present disclosure describes a hanging storage system comprising a hanging rail (“rail”) and hanging tabs (“tabs”). Further, the hanging storage system comprises a backpack clip and a storage container. As shown in FIG. 1, the tabs of the present a circular or rounded portion at the top, which will be referred to as the “button”. Extending downward from the button is a thin portion, the length of which may vary as shown in FIG. 2. At the bottom of the tab is a small opening, through which a zip tie, string, rope, bungee, or similar tying method may be used. The tie loops around the object the user wishes to hang or attach to the tab and through the opening. An example can be seen in FIG. 3, which shows the top portion of an antler attached to the tab via a string and bungee ball. Other tying methods are contemplated and would function similarly. In a preferred embodiment, the tabs are made of thermoplastic polyurethane (TPU) to allow for greater flexibility. Other embodiments may use different materials.

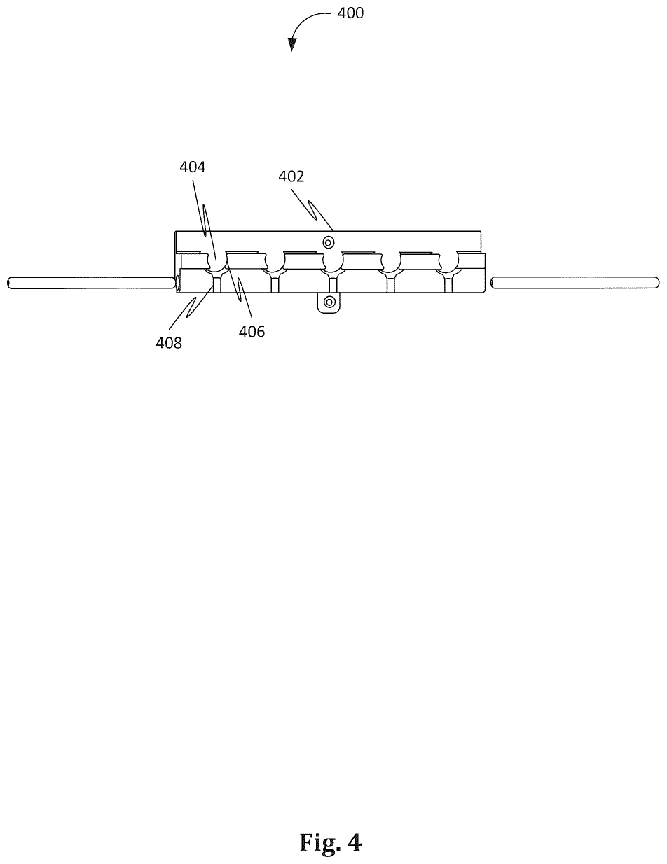

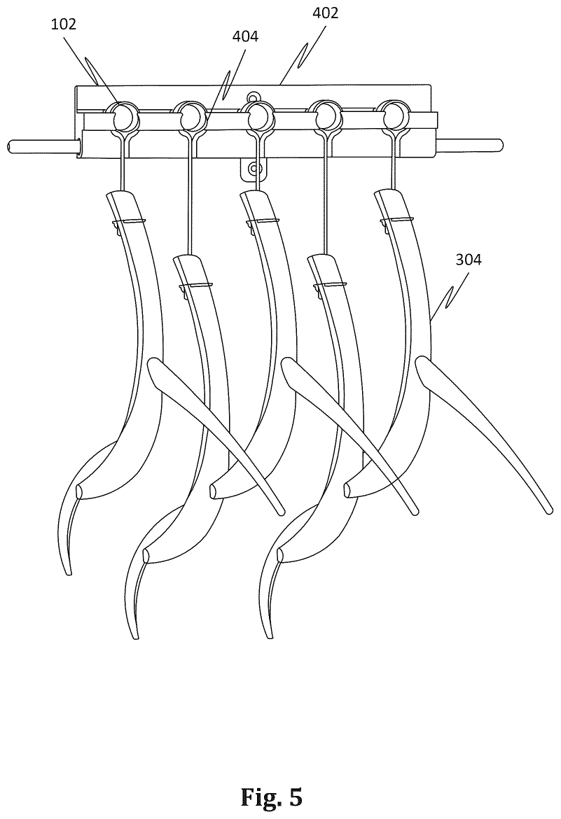

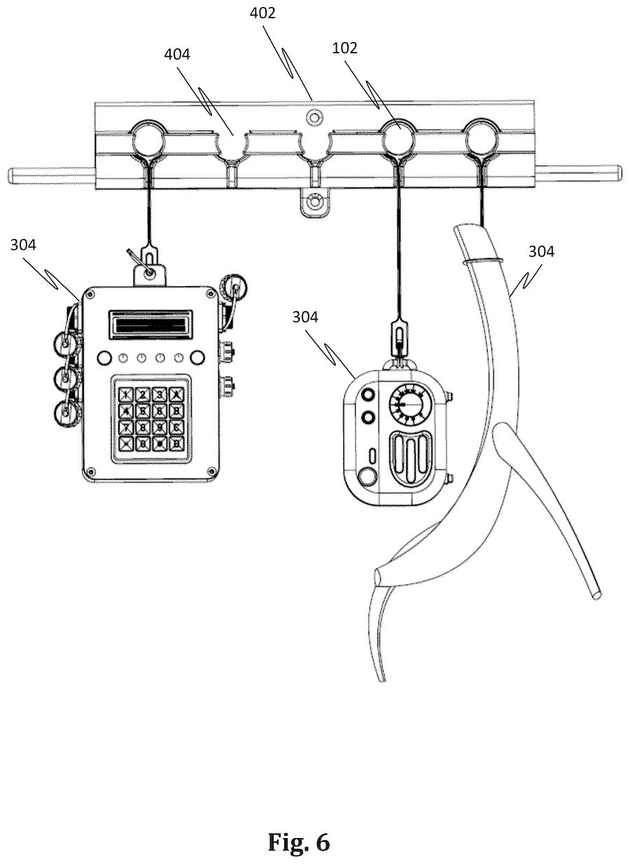

Further, one embodiment of the rail of the hanging storage system is shown in FIG. 4. The rail comprises one or more cutouts shaped to match the tabs and hold them in place. The rounded cutouts match the shape of the button, allowing the tabs to hang from the rail, as shown in FIGS. 5 and 6. The number of objects that can be stored on the rail may vary depending on the number of cutouts, and the varying lengths of the tabs allow the user to display a variety of items in a desired arrangement. The rail may be attached to a wall using standard methods, such as screws.

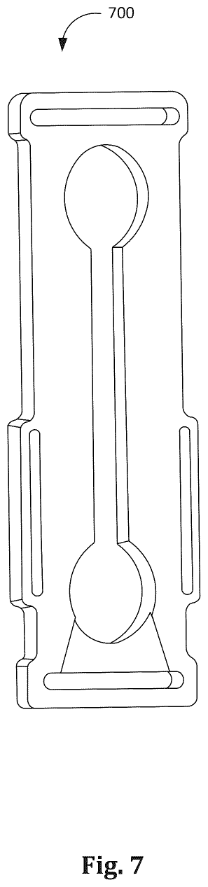

Further, FIG. 7 shows a backpack clip of the hanging storage system. The clip allows the user to store objects by attaching them to a backpack. The clip comprises a plurality of openings around the edges, allowing the clip to attach to a backpack or other portable item. In the middle of the clip is a cutout, with rounded portions on either end and a narrower portion connecting the rounded portions. This cutout allows the user to place one or more tabs through the opening, allowing objects to be carried on the backpack using the clip.

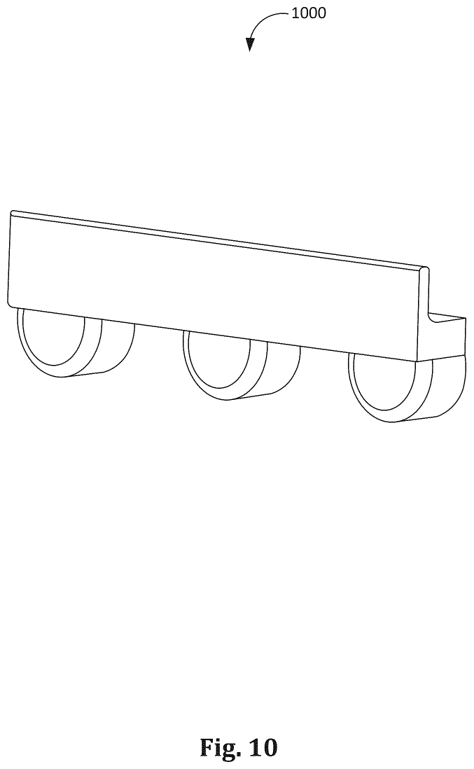

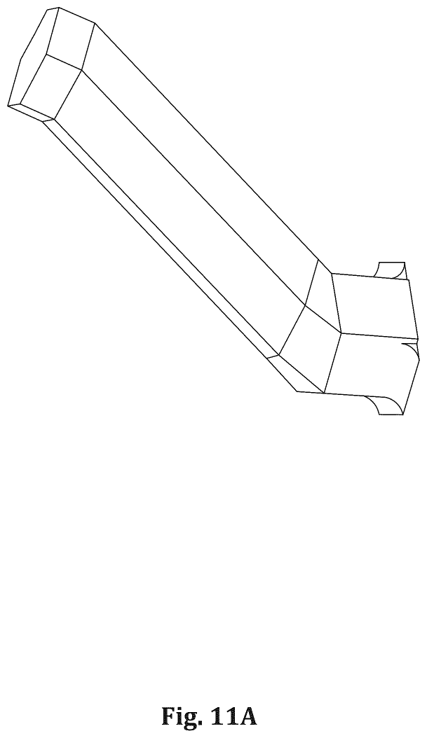

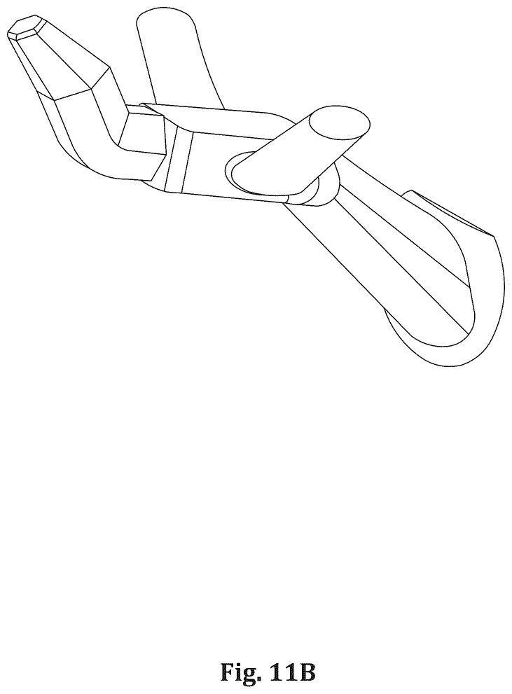

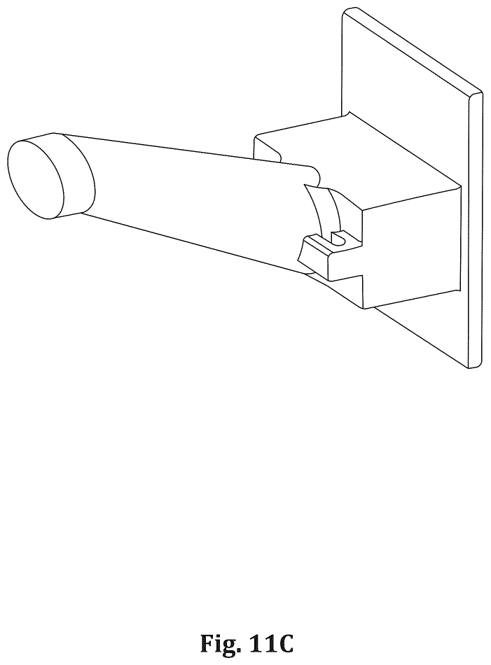

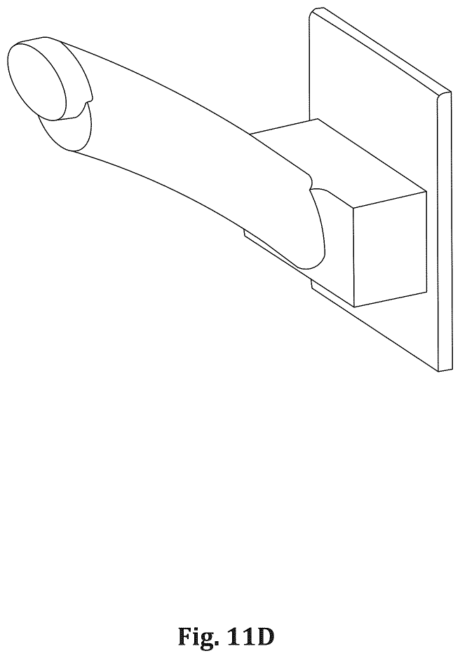

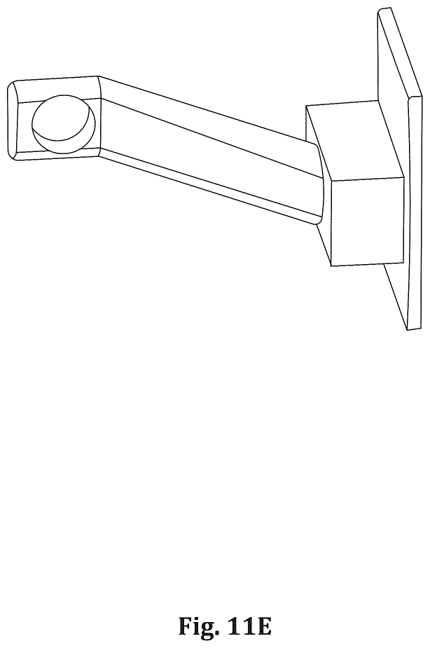

Further, the hanging storage system may further comprise mounting accessories utilizing the tab shape and structure, several of which can be seen in FIG. 11A to FIG. 11E. Further, the backpack clip hanging from an attachment to the rail which connects via two tabs. FIG. 10 shows an additional storage rail which can connect to the main rail via three buttons. Other embodiments of this additional storage rail may have any number of buttons.

In some embodiments, the mounting accessory may be a “skull mount”. The skull mount may attach to the rail via tabs as shown, and a shaft extends from the mount at an upward angle, allowing objects to hang securely. Although referred to herein as a skull mount, the hanging utility is not limited to skulls. Any object which fits on the mount may be hung and stored.

In some embodiments, the present disclosure may describe a storage arrangement featuring a plurality of rails and accessories, including storage bins and shoe racks. The storage bins may hang from the storage rail, or via any other suitable and secure means. The shoe rack attachment comprises a base on each end, which hang from the rail of the hanging storage system using the tabs, and a rod connecting them, which holds the shoes in place against the wall.

Further, the hanging storage system may additionally comprise a storage container. The storage container comprises a plurality of cutouts around the sides, said cutouts being shaped to match the shape of the tabs. Tabs may then be stored within the cutouts. Inside the container, the user may place the zip ties or other tying methods.

In some embodiments, a narrow slit is cut through a pipe. The tabs of the hanging storage system may be inserted into the pipe, with the thin portion going through the slit. Any number of items may be carried with the pipe depending on the length.

In some embodiments, the tab length may be adjusted using a variable screw mechanism that allows for fine-tuning the distance between tabs based on the specific needs of the items being stored. This adjustment could be achieved via a knob located at the end of each rail segment, enabling users to customize the spacing.

Further, the tabs may be implemented with a telescoping design where the length can be extended or retracted by means of a slider mechanism, allowing for quick and easy adjustments without the need for tools.

In some embodiments, the backpack clip may be designed as a separate clamp that attaches to the edge of a backpack or briefcase and secures the hanging rail system in place. This would allow users to carry their stored items with them without needing additional storage solution.

Further, the backpack clip could be integrated into the design of the backpack itself, using a dedicated pocket or compartment that houses the hanging rail system until it is needed.

In some embodiments, the storage container may be designed with built-in cutouts that correspond to the specific dimensions of the tabs and other accessories. These cutouts could be located on the sides or top of the container to ensure that all necessary items are stored in an organized manner.

Further, the storage container could feature a modular design where separate compartments can be added or removed as needed, allowing for maximum flexibility in how items are stored.

In some embodiments, modular mounting accessories may be designed as interchangeable modules that can be snapped onto the hanging rail system. These modules could include features like additional storage compartments or specialized holders for specific items.

Further, the accessories may use a snap-in system where each accessory is designed to fit into specific slots or connectors on the main rail, ensuring a perfect fit and easy installation.

In some embodiments, an alternative method could involve using a slit pipe design where the pipe is cut at specific intervals to allow tabs to fit through. This slit pipe may be adjustable to accommodate different tab sizes or spacing requirements, making it suitable for various installation scenarios.

Further, the pipe slit method could be replaced by a flexible mounting system that uses elastic materials or adjustable brackets to secure the hanging rail without the need for drilling or cutting.

In some embodiments, scalable attachment capabilities could be implemented using magnetic strips or universal connectors that allow for easy attachment of various accessories. These attachments could be designed to fit into specific slots or brackets on the main rail, ensuring compatibility with different types of accessories.

Further, a modular attachment system may be used where each accessory is designed to connect via specific tabs or hooks, allowing for a seamless and stable integration.

In some embodiments, secure mounting assemblies may include features like reinforced flanges or U-shaped cradles that provide a sturdy base for heavier items. These designs could be constructed from durable materials such as metal or high-strength plastics to ensure longevity and stability.

Further, the mounting assembly could use dual-cradle systems where two separate cradles work together to distribute the weight evenly, minimizing the risk of damage to the items being stored.

In some embodiments, interchangeable tabs may be designed with different lengths, shapes, and materials to cater to a wide range of storage requirements. Users could swap out tabs based on the specific items they are storing, ensuring optimal performance each time.

Further, tabs could incorporate specialized features like anti-slip surfaces or textured finishes that enhance grip and prevent items from moving around.

In some embodiments, bi-layered tabs could be implemented using composite materials where two layers of different materials are bonded together. This design could offer increased durability and strength, allowing the hanging rail system to support heavier loads without deforming or breaking.

Further, the tabs could be constructed with layered metal plates that provide additional rigidity and stability, making them suitable for heavy-duty applications.

In some embodiments, a smart integration system could be added that uses IoT sensors or tracking devices to monitor items in real-time. This system could alert users when certain items are running low or when the hanging rail system is being accessed outside of permitted times.

Further, the system could include automated mechanisms that reorganize items based on usage patterns, ensuring that frequently accessed items are stored in more convenient locations.

In some embodiments, an anti-tilt mechanism could be designed using weighted bases or balancing mechanisms that help keep items stable. These mechanisms could be integrated into the design of the tabs or storage containers to ensure that items remain upright and secure.

Further, the system could incorporate motion sensors or balance bars that detect when an item is tilting and automatically adjust its position or provide alerts to prevent potential damage.

In some embodiments, a customizable width adjustment feature could be added that allows users to expand or contract the width of the hanging rail system based on their specific needs. This could be achieved through adjustable brackets or sliding rails that allow for easy expansion or contraction of the system's width.

Further, the system could include modular segments that can be added or removed to adjust the overall width, providing flexibility in how items are stored.

FIG. 1 is an illustration of a hanging tab 100, in accordance with some embodiments.

Accordingly, the apparatus facilitating hanging and storing of an object 304 may include a hanging tab. Further, the hanging tab may include a circular button portion 102 disposed at a first longitudinal end of the hanging tab. Further, the circular button portion 102 includes a flat top surface and a flat bottom surface. Further, the circular button portion 102 further includes a continuous cylindrical sidewall which may be configured to connect the flat top surface to the flat bottom surface. Further, the continuous cylindrical sidewall may be further configured for circumferentially enclosing the button portion. Further, the hanging tab may include a connecting shaft portion 104 extending from the flat bottom surface of the circular button portion 102. Further, the connecting shaft portion 104 may be designed to terminate at a second longitudinal end associated with the hanging tab. Further, the second longitudinal end may be positioned opposite to the first longitudinal end. Further, the connecting shaft portion 104 includes each of an elongated profile and a uniform cross-sectional profile in relation to a longitudinal axis associated with the connecting shaft portion 104. Further, the connecting shaft portion 104 may be designed to be narrower in relation to the circular button portion 102 enabling one or more of a flexible suspension and an insertion into a slit. Further, the hanging tab may include a terminal eyelet portion 106 disposed at the second longitudinal end of the hanging tab. Further, the terminal eyelet portion 106 includes a flat annular ring 108 oriented orthogonally to the longitudinal axis associated with the connecting shaft portion 104. Further, the flat annular ring 108 includes a central through-hole 110 defining an aperture which may be configured for accommodating a flexible tie member 302. Further, the terminal eyelet portion 106 may be designed for integrally forming with the connecting shaft portion 104. Further, the integrally forming of the terminal eyelet portion 106 with the connecting shaft portion 104 may be configured to enable a connection of the hanging tab to the object 304. Further, the apparatus facilitating hanging and storing of an object 304 may include a rail structure which may be configured for facilitate each of a receiving and a retaining of two or more hanging tabs. Further, the rail structure may include a longitudinal bar 402 having a front surface and a rear surface. Further, the longitudinal bar 402 may be configured for mounting onto a vertical support. Further, the rail structure may include two or more shaped through-holes 404 defined in the front surface of the longitudinal rail. Further, the each of the two or more shaped though-holes may be configured to extend completely from the front surface to the rear surface. Further, each of the shaped through-hole may include a rounded upper portion 406 dimensioned to securely receive the circular button portion 102 associated with the hanging tab. Further, each of the shaped through-hole may include a narrow vertically elongated slit 408 designed to extend downwardly from the rounded upper portion 406. Further, the narrow vertically elongated slit 408 includes a width dimensioned for matching a diameter associated with the connecting shaft portion 104. Further, the each of the two or more hanging tabs may be configured for vertical insertion into the rail structure. Further, the vertical insertion of each of the two or more hanging tabs may be facilitated by two or more insertion steps. Further, the two or more insertion steps includes an alignment step representing aligning of the circular button portion 102 with the rounded upper portion 406 of each of the two or more shaped through-holes 404 and a sliding step representing sliding of the connecting shaft portion 104 downward through the narrow vertically elongated slit 408. Further, the two or more insertion steps may be configured to facilitate a mounting of each of the two or more hanging tabs to the rail structure. Further, the two or more shaped through-holes 404 may be arranged to be spaced in one or more of a regular interval and two or more variable intervals along the longitudinal axis associated with the rail structure.

FIG. 2 is an illustration of a plurality of hanging tabs with varied lengths, in accordance with some embodiments.

In some embodiments, the flexible tie member 302 includes one or more of a string, a rope, a bungee cord, and a zip tie. Further, the flexible tie member 302 may be configured for looping through the central through-hole 110 of the terminal eyelet portion 106 associated with the hanging tab. Further, the accommodating of the flexible tie member 302 may be further based on the looping. Further, the flexible tie member 302 may be further configured for looping the object 304. Further, the looping of the object 304 with the flexible tie member 302 may be further configured to support a hanging orientation associated with the object 304 based on the mounting of each of the two or more hanging tabs to the rail structure.

FIG. 3 illustrates an object 304 attached to the hanging tab using each of a flexible tie member 302 and a spherical stopper 306, in accordance with some embodiments.

In some embodiments, the hanging tab may be further configured for provisioning a functional support for a mounting accessory in relation to rail structure. Further, the mounting accessory includes an angled hanging arm which may be configured to extend obliquely in one or more of a downward and outward direction from the rail structure. Further, the angled hanging arm may be further configured for terminating in a free-distal end. Further, the angled hanging arm may be adapted for supporting the object 304 by gravity.

FIG. 4 illustrates a front view of a rail structure 400, in accordance with some embodiments.

In some embodiments, the mounting accessory further includes a planar mounting plate 900 positioned orthogonally to the rail structure. Further, the planar mounting plate 900 includes a rectangular upper surface which may be configured to support an external article. Further, the external article includes one or more of a bracket, a container, and a hook assembly.

In some embodiments, the mounting accessory further includes a storage bin bracket which may be configured for supporting a detachable storage bin. Further, the storage bin bracket includes a rearward-facing surface. Further, the storage bin bracket includes at least two engagement projections disposed on the rearward-facing surface. Further, the at least two engagement projections facilitate the supporting of the detachable storage bin.

FIG. 5 illustrates a plurality of antlers attached and hanging from the rail structure 400, in accordance with some embodiments.

In some embodiments, the mounting accessory further includes a multi-engagement projection member. Further, the multi-engagement projection member includes a plurality of spatially offset engagement projections along a rear surface associated with the multi-engagement projection member. Further, each of the plurality of spatially offset engagement projections includes the circular button portion 102 and the continuous shaft portion dimensioned for facilitating an insertion into each of the two or more shaped through-holes 404 associated with the rail structure.

FIG. 6 illustrates a plurality of objects attached and hanging from the rail structure 400, in accordance with some embodiments.

In some embodiments, the plurality of spatially offset engagement projections includes a first spatially offset engagement projection, a second spatially offset engagement projection, and a third spatially offset engagement projection. Further, the first spatially offset engagement projection, the second spatially offset engagement projection, and the third spatially offset engagement projection may be linearly arranged along a common backplane.

In some embodiments, the hanging tab may be fabricated from a flexible thermoplastic polyurethane material. Further, the TPU material may be configured for provisioning a resilience and a bendability associated with the hanging tab. Further, the TPU material may be further configured to accommodate a varied hanging force and a varied insertion configuration.

In some embodiments, the mounting accessory includes an engagement projection which may be configured for facilitating the functional support. Further, the engagement projection includes a latch mechanism. Further, the latch mechanism includes a pivotable locking element and a mating surface feature. Further, each of the pivotable locking element and the mating surface feature may be further configured for facilitating a secure attachment and a quick-release disengagement of the mounting accessory from the rail structure.

In some embodiments, the rail structure further includes a retention feature which may be configured for resisting an unintentional detachment of the hanging tab. Further, the retention feature may be positioned proximate to each of the two or more shaped through-holes 404. Further, the retention feature includes one or more of a groove, a detent, and a constriction zone.

In some embodiments, the bungee cord includes each of a bungee loop and a spherical stopper 306. Further, the bungee loop may be configured for passing through the terminal eyelet facilitating the looping. Further, the bungee loop may be further configured for securing the object 304 under tension.

In some embodiments, the vertical support includes one or more of a wall, a top edge, and a bottom edge.

In some embodiments, the mounting of the rail structure on the wall may be based on a rear flange surface comprising two or more countersunk screw holes which may be configured for flush securement to a vertical wall plane associated with the wall.

FIG. 7 illustrates a backpack adapter plate 700, in accordance with some embodiments.

In some embodiments, the apparatus may further include a backpack adapter plate 700. Further, the backpack adapter plate 700 includes one or more of a rail-like attachment aperture along a central body associated with the backpack adapter plate 700. Further, the backpack adapter plate 700 further includes two or more strap passage slots disposed along a periphery associated with the backpack adapter plate 700. Further, each of the rail-like attachment aperture and the two or more strap passage slots may be configured to enable tethering of the object 304 to a wearable item. Further, the wearable item includes a backpack.

In some embodiments, the rail structure includes a pipe-shaped body, may. Further, the pipe-shaped body includes a longitudinal slit dimensioned for receiving the connecting shaft portion 104 associated with the hanging tab. Further, the longitudinal slit may be configured for allowing the circular button portion 102 of the hanging tab to be inserted into an interior cavity associated with the pipe-shaped body.

In some embodiments, the mounting accessory may include a skull mount fixture comprising a forward-extending arm connected to the engagement projection associated with the mounting projection. Further, the forward-extending arm may be configured to terminate in an upwardly angled cylindrical post. Further, the forward-extending arm may be further adapted for receiving and supporting the object 304. Further, the object 304 includes a taxidermy skull.

In some embodiments, the engagement projection includes two or more engagement projections, may. Further, each of the two or more engagement projections may be distributed in a spaced configuration on the mounting accessory facilitating an engagement within a plurality of a non-adjacent rail structures. Further, the engagement within the two or more rail structures may be further configured for enabling an enhanced load distribution.

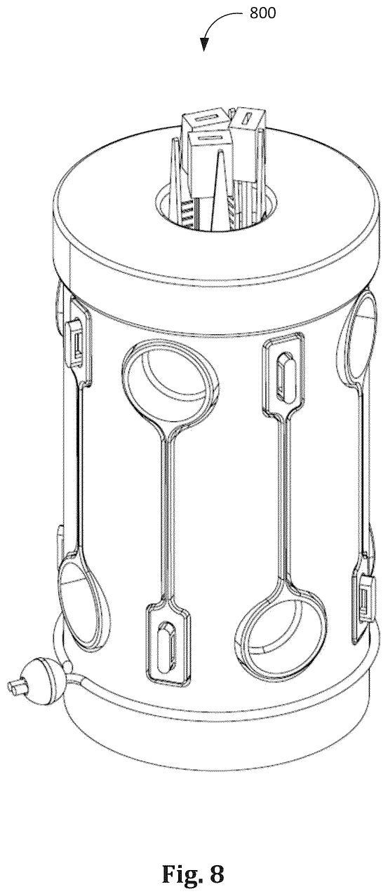

FIG. 8 illustrates a tool holding bracket 800, in accordance with some embodiments.

In some embodiments, the mounting accessory includes a tool holding bracket 800 which may be configured retaining of one or more of a tool and a utensil. Further, the tool holding bracket 800 includes a notched cradle facilitating the retaining.

In some embodiments, each of the rail structure and the mounting accessory may be integrally molded into a monolithic polymer extrusion representing a surface feature associated with each of the rail structure and the mounting accessory. Further, the surface feature includes one or more of an anti-slip texture and a rounded corner.

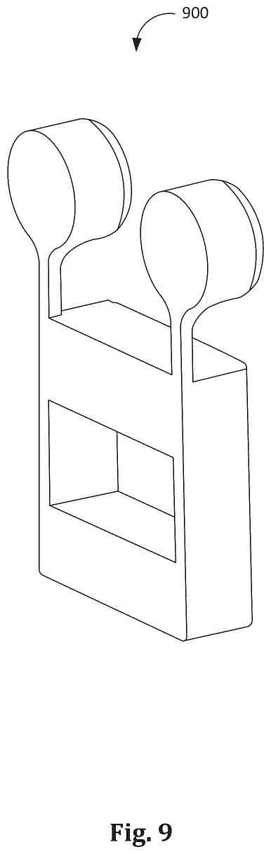

FIG. 9 illustrates a planar mounting plate 900, in accordance with some embodiments.

In some embodiments, the surface feature may be configured to enhance one or more of a durability and a usability associated with the apparatus.

FIG. 10 illustrates a modular sliding track 1000, in accordance with some embodiments.

In some embodiments, the mounting accessory further includes a modular sliding track 1000. Further, the modular sliding track 1000 may be configured for extending transversely from the hanging tab. Further, the modular sliding track 1000 includes a linear guiding slot which may be configured for receiving and positioning an additional hanging module associated with the apparatus.

In some embodiments, the mounting accessory includes a pivotable base which may be configured for allowing the object 304 to be articulated relative to the rail structure 304 for attaining an adjustable angle display.

FIG. 11A illustrates a mounting accessory, in accordance with some embodiments. In accordance with FIG. 11A, the apparatus comprises an elongated regular hexagonal prismatic bar comprising a uniform cross-section along a central span associated with the elongated regular hexagonal prismatic bar. Further, the elongated regular hexagonal prismatic bar comprises one or more of planar side faces extending between a closed hexagonal first end face and a tapered second end region. Further, the one or more of planar side faces slope inward to three truncated junction surfaces. Further, the elongated regular hexagonal prismatic bar comprises a rectangular engagement block is formed rigidly on the second end region. Further, the rectangular engagement block comprises a rear mounting face positioned to be coplanar with an axis associated with the elongated regular hexagonal prismatic bar. Further, the rear mounting face is further configured for abutting a flat support, an inclined front face canted about fifteen degrees relative to the axis, and two lateral side faces.

Further, the rectangular engagement block comprises a top face, a bottom face, and an arcuate upper hook ledge projecting from an upper portion associated with the inclined front face. This ledge is defined by a constant-radius exterior surface that spans between the lateral faces and meets the front face along a smooth concave transition. Further, a lower hook ledge projects from the lower edge of the bottom face. Further, the lower hook ledge comprises an outer curved surface concentric with the axis associated with the elongated regular hexagonal prismatic bar. Further, the outer curved surface is further configured to blend into a block bottom using a convex fillet.

FIG. 11B illustrates a mounting accessory, in accordance with some embodiments. In some embodiments, FIG. 11B illustrates a fixed hex-bar hook comprising an engagement block. Further, the engagement block comprises a circular pivot block configured to be centered on a through-bore that functions as a rotary journal. Further, the circular pivot block features two elongate hook arms. Further, each of the two elongate hook arms comprises each of a proximal section configured to be received in the through-bore and a distal free end comprising a flat circular face. Further, a U-shaped stowage channel is configured to be defined at a bottom portion associated with the circular pivot block using two parallel flanges. Further, the circular pivot block comprises an inner floor configured to be coplanar with a lowest fillet and dimensioned to receive both elongate hook arms in a side-by-side configuration when rotated downward. Further, the fixed hex-bar hook comprises a plurality of semi-circular notches on each of the plurality of lateral side faces. Further, the plurality of semi-circular notches is configured to accommodate up to ninety degrees of rotation associated with each of the two elongate hook arm in each direction.

FIG. 11C illustrates a mounting accessory, in accordance with some embodiments. In some embodiments, FIG. 11C illustrates the mounting accessory comprising a rigidly affixed housing block supported by a rectangular mounting plate. Further, the block comprises a plurality of faces. Further, the plurality of faces comprises a front face, a rear mounting face, a top face, a bottom face, a first side face, and a second side face. Further, each of the plurality of faces are connected using a cylindrical pivot bore. Further, the cylindrical pivot bore is configured to serve as the journal for a single hook arm. Further, in a horizontally deployed configuration, the single hook arm projects forward through a front portion associated with the rigidly affixed housing.

Further, the rigidly affixed housing block comprises a small latch block affixed to a bottom portion using a living-hinge seam. Further, the small latch hook comprises a top surface configured to carry a curved detent hook. Further, rotation of the single hook arm downward into a vertical stowed position facilitates the curved detent hook to engage a complementary slot on a periphery associated with the single hook arm. Further, the single hook arm is configured to seat into a semi-cylindrical recess formed at the intersection of each of a one side face and the bottom face.

FIG. 11D illustrates a mounting accessory, in accordance with some embodiments. In some embodiments, FIG. 11D illustrates a single-arm detent design but omits the living-hinge latch block and peripheral slot. Further, instead the rigidly affixed housing block and a cylindrical hook arm are configured to rely on a semi-cylindrical stowage pocket formed in the each of the bottom portion and one side face associated with the block. Further, the semi-cylindrical stowage pocket is dimensioned to create an interference fit around the singlet-arm when on rotation into the vertical stow position. Further, the rotation is configured for producing a friction retaining the singlet-arm against unintended rotation.

FIG. 11E illustrates a mounting accessory, in accordance with some embodiments. In accordance with FIG. 11E, a mounting plate and a rectangular block are provided with a pivot bore through their side faces configured to support a cylindrical hook arm. Further, the cylindrical hook arm is configured of facilitating a 180-degree rotation. Further, the front face associated with the rectangular block is penetrated by a full-depth rectangular cavity, leaving only a thin peripheral wall. Further, the full-depth rectangular cavity is configured to extend rearward to within a small clearance of a rear face associated with the rectangular block. Further, a width and a height associated with the full-depth rectangular cavity is designed for exceeding the diameter of the arm by a slight margin. Further, the exceeding of the diameter enables the arm to rotate entirely into the full-depth rectangular cavity.

Although the invention has been explained in relation to its preferred embodiment, it is to be understood that many other possible modifications and variations can be made without departing from the spirit and scope of the invention as hereinafter claimed.

What is claimed is:

1. An apparatus facilitating hanging and storing of an object, comprising:
a hanging tab comprising:
a circular button portion disposed at a first longitudinal end of the hanging tab, wherein the circular button portion comprises a flat top surface and a flat bottom surface, wherein the circular button portion further comprises a continuous cylindrical sidewall configured to connect the flat top surface to the flat bottom surface, wherein the continuous cylindrical sidewall is further configured for circumferentially enclosing the button portion;
a connecting shaft portion extending from the flat bottom surface of the circular button portion, wherein the connecting shaft portion is designed to terminate at a second longitudinal end associated with the hanging tab, wherein the second longitudinal end is positioned opposite to the first longitudinal end, wherein the connecting shaft portion comprises each of an elongated profile and a uniform cross-sectional profile in relation to a longitudinal axis associated with the connecting shaft portion, wherein the connecting shaft portion is designed to be narrower in relation to the circular button portion enabling at least one of a flexible suspension and an insertion into a slit; and
a terminal eyelet portion disposed at the second longitudinal end of the hanging tab, wherein the terminal eyelet portion comprises a flat annular ring oriented orthogonally to the longitudinal axis associated with the connecting shaft portion, wherein the flat annular ring comprises a central through-hole defining an aperture configured for accommodating a flexible tie member, wherein the terminal eyelet portion is designed for integrally forming with the connecting shaft portion, wherein the integrally forming of the terminal eyelet portion with the connecting shaft portion is configured to enable a connection of the hanging tab to the object;
a rail structure configured for facilitate each of a receiving and a retaining of a plurality of hanging tabs, wherein the rail structure comprises:
a longitudinal bar having a front surface and a rear surface, wherein the longitudinal bar is configured for mounting onto a vertical support; and
a plurality of shaped through-holes defined in the front surface of the longitudinal rail, wherein each of the plurality of shaped though-holes is configured to extend completely from the front surface to the rear surface, wherein each of the shaped through-hole comprises:
a rounded upper portion dimensioned to securely receive the circular button portion associated with the hanging tab; and
a narrow vertically elongated slit designed to extend downwardly from the rounded upper portion, wherein the narrow vertically elongated slit comprises a width dimensioned for matching a diameter associated with the connecting shaft portion, wherein the each of the plurality of hanging tabs is configured for vertical insertion into the rail structure, wherein the vertical insertion of each of the plurality of hanging tabs is facilitated by a plurality of insertion steps, wherein the plurality of insertion steps comprises an alignment step representing aligning of the circular button portion with the rounded upper portion of each of the plurality of shaped through-holes and a sliding step representing sliding of the connecting shaft portion downward through the narrow vertically elongated slit, wherein the plurality of insertion steps is configured to facilitate a mounting of each of the plurality of hanging tabs to the rail structure, wherein the plurality of shaped through-holes are arranged to be spaced in at least one of a regular interval and a plurality of variable intervals along the longitudinal axis associated with the rail structure.

2. The apparatus of claim 1, wherein the flexible tie member comprises at least one of a string, a rope, a bungee cord, and a zip tie, wherein the flexible tie member is configured for looping through the central through-hole of the terminal eyelet portion associated with the hanging tab, wherein the accommodating of the flexible tie member is further based on the looping, wherein the flexible tie member is further configured for looping the object, wherein the looping of the object with the flexible tie member is further configured to support a hanging orientation associated with the object based on the mounting of each of the plurality of hanging tabs to the rail structure.

3. The apparatus of claim 1, wherein the hanging tab is further configured for provisioning a functional support for a mounting accessory in relation to rail structure, wherein the mounting accessory comprises an angled hanging arm configured to extend obliquely in at least one of a downward and outward direction from the rail structure, wherein the angled hanging arm is further configured for terminating in a free-distal end, wherein the angled hanging arm is adapted for supporting the object by gravity.

4. The apparatus of claim 3, wherein the mounting accessory further comprises a planar mounting plate positioned orthogonally to the rail structure, wherein the planar mounting plate comprises a rectangular upper surface configured to support an external article, wherein the external article comprises at least one of a bracket, a container, and a hook assembly.

5. The apparatus of claim 3, wherein the mounting accessory further comprises a storage bin bracket configured for supporting a detachable storage bin, wherein the storage bin bracket comprises a rearward-facing surface, wherein the storage bin bracket comprises at least two engagement projections disposed on the rearward-facing surface, wherein the at least two engagement projections facilitate the supporting of the detachable storage bin.

6. The apparatus of claim 5, wherein the mounting accessory further comprises a multi-engagement projection member, wherein the multi-engagement projection member comprises a plurality of spatially offset engagement projections along a rear surface associated with the multi-engagement projection member, wherein each of the plurality of spatially offset engagement projections comprises the circular button portion and the continuous shaft portion dimensioned for facilitating an insertion into each of the plurality of shaped through-holes associated with the rail structure.

7. The apparatus of claim 6, wherein the plurality of spatially offset engagement projections comprises a first spatially offset engagement projection, a second spatially offset engagement projection, and a third spatially offset engagement projection, wherein the first spatially offset engagement projection, the second spatially offset engagement projection, and the third spatially offset engagement projection are linearly arranged along a common backplane.

8. The apparatus of claim 1, wherein the hanging tab is fabricated from a flexible thermoplastic polyurethane material, wherein the TPU material is configured for provisioning a resilience and a bendability associated with the hanging tab, wherein the TPU material is further configured to accommodate a varied hanging force and a varied insertion configuration.

9. The apparatus of claim 3, wherein the mounting accessory comprises an engagement projection configured for facilitating the functional support, wherein the engagement projection comprises a latch mechanism, wherein the latch mechanism comprises a pivotable locking element and a mating surface feature, wherein each of the pivotable locking element and the mating surface feature is further configured for facilitating a secure attachment and a quick-release disengagement of the mounting accessory from the rail structure.

10. The apparatus of claim 1, wherein the rail structure further comprises a retention feature configured for resisting an unintentional detachment of the hanging tab, wherein the retention feature is positioned proximate to each of the plurality of shaped through-holes, wherein the retention feature comprises at least one of a groove, a detent, and a constriction zone.

11. The apparatus of claim 2, wherein the bungee cord comprises each of a bungee loop and a spherical stopper, wherein the bungee loop is configured for passing through the terminal eyelet facilitating the looping, wherein the bungee loop is further configured for securing the object under tension.

12. The apparatus of claim 1, wherein the vertical support comprises at least one of a wall, a top edge, and a bottom edge.

13. The apparatus of claim 12, wherein the mounting of the rail structure on the wall is based on a rear flange surface comprising a plurality of countersunk screw holes configured for flush securement to a vertical wall plane associated with the wall.

14. The apparatus of claim 1, further comprising a backpack adapter plate, wherein the backpack adapter plate comprises at least one of a rail-like attachment aperture along a central body associated with the backpack adapter plate, wherein the backpack adapter plate further comprises a plurality of strap passage slots disposed along a periphery associated with the backpack adapter plate, wherein each of the rail-like attachment aperture and the plurality of strap passage slots are configured to enable tethering of the object to a wearable item, wherein the wearable item comprises a backpack.

15. The apparatus of claim 1, wherein the rail structure comprises a pipe-shaped body, wherein the pipe-shaped body comprises a longitudinal slit dimensioned for receiving the connecting shaft portion associated with the hanging tab, wherein the longitudinal slit is configured for allowing the circular button portion of the hanging tab to be inserted into an interior cavity associated with the pipe-shaped body.

16. The apparatus of claim 9, wherein the mounting accessory comprises a skull mount fixture comprising a forward-extending arm connected to the engagement projection associated with the mounting projection, wherein the forward-extending arm is configured to terminate in an upwardly angled cylindrical post, wherein the forward-extending arm is further adapted for receiving and supporting the object, wherein the object comprises a taxidermy skull.

17. The apparatus of claim 9, wherein the engagement projection comprises a plurality of engagement projections, wherein each of the plurality of engagement projections are distributed in a spaced configuration on the mounting accessory facilitating an engagement within a plurality of a non-adjacent rail structures, wherein the engagement within the plurality of rail structures is further configured for enabling an enhanced load distribution.

18. The apparatus of claim 3, wherein the mounting accessory comprises a tool holding bracket configured retaining of at least one of a tool and a utensil, wherein the tool holding bracket comprises a notched cradle facilitating the retaining.

19. The apparatus of claim 3, wherein each of the rail structure and the mounting accessory are integrally molded into a monolithic polymer extrusion representing a surface feature associated with each of the rail structure and the mounting accessory, wherein the surface feature comprises at least one of an anti-slip texture and a rounded corner.

20. The apparatus of claim 19, wherein the surface feature is configured to enhance at least one of a durability and a usability associated with the apparatus.
